(19) United States
(12) Patent Application Publication
(10) Pub. No.: US 2025/0130567 A1
(43) Pub. Date: Apr. 24, 2025

(54) SYSTEMS AND METHODS TO EXPLAIN AN ARTIFICIAL INTELLIGENCE POLICY OF BEHAVIOR WITH CAUSAL REASONING

(71) Applicant: GM GLOBAL TECHNOLOGY OPERATIONS LLC, Detroit, MI (US)

(72) Inventors: Claudia GOLDMAN-SHENHAR, Mevasseret Zion (IL); Yuval ZAK, Gedera (IL); Ronit BUSTIN, Kfar Saba (IL); Ofer SARAF, Tel Aviv (IL)

(21) Appl. No.: 18/492,313

(22) Filed: Oct. 23, 2023

(51) Int. Cl. G05D 1/00; G06F 16/901

(52) U.S. Cl. CPC G05D 1/0088; G06F 16/9024

(57) ABSTRACT

A method includes generating a data structure including states and actions to be executed at those states as determined by an AI policy of behavior, determining, with a first computing system that is offline, state factors associated with the states and responsibility scores for the state factors, each responsibility score indicating a causal impact for each of the actions associated with one of the states, generating, with the first computing system, a causal ML model based on the state factors and the responsibility scores, determining, with a second computing system that is online based on the causal ML model, state factors associated with a current state, and identifying one or more of the state factors as a causal reason for an action resulting from the current state. Other example methods and systems for providing explanation of an AI policy of behavior with causal reasoning are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to systems and methods to explain an artificial Intelligence (AI) policy of behavior with causal reasoning.

AI can be used in a fully autonomous or semi-autonomous vehicle to determine an action for the vehicle to take. For example, AI algorithms may be applied to compute and determine driving behaviors for such vehicles. In such examples, graphical models, such as probability trees, are often used for automated decision making. Sometimes, information about the behavior of the automated vehicle may be provided by design and heuristic rules.

### SUMMARY

A method for providing explanation of an AI policy of behavior with causal reasoning includes generating a data structure including states and actions to be executed at those states as determined by the AI policy of behavior, determining, with a first computing system that is offline, state factors associated with the states and responsibility scores for the state factors, each responsibility score indicating a causal impact for each of the actions associated with one of the states, generating, with the first computing system, a causal machine learning (ML) model based on the state factors and the responsibility scores, determining, with a second computing system that is online based on the generated causal ML model, state factors associated with a current state, and identifying one or more of the state factors as a causal reason for an action resulting from the current state.

In other features, the method further includes reformulating the states and the actions into a table represented by indexes based on one or more criterion.

In other features, the AI policy of behavior is an AI policy of behavior for an autonomous vehicle, and the one or more criterion includes a defined number of sections each representing a different area adjacent to the autonomous vehicle.

In other features, the method further includes assigning values for the indexes based on a defined discretization formulation.

In other features, determining, with the first computing system that is offline, the state factors and the responsibility scores includes determining the state factors and the responsibility scores based on the values for the indexes.

In other features, the AI policy of behavior is an AI policy of behavior for an autonomous vehicle, and the state factors are associated with a semantic abstraction.

In other features, the semantic abstraction includes one or more sections adjacent to the autonomous vehicle.

In other features, the method further includes displaying, on a display in the autonomous vehicle, a notification regarding the causal reason for the action resulting from the current state.

In other features, the notification includes a graphical representation highlighting an area adjacent to the autonomous vehicle in which at least one section is located.

In other features, the notification includes a description of the area adjacent to the autonomous vehicle in which the at least one section is located.

In other features, a size of the area adjacent to the autonomous vehicle is adjustable based on a parameter of the autonomous vehicle and/or a traffic distribution density near the autonomous vehicle.

In other features, a color of the highlighted area is adjustable based on a confidence value associated with the at least one section.

A method for providing explanation of an AI policy of behavior with causal reasoning includes receiving a causal ML model, determining, based on the causal ML model, state factors associated with a current state, identifying one or more of the state factors as a causal reason for an action resulting from the current state, and displaying a notification regarding the causal reason for the action resulting from the current state.

In other features, the AI policy of behavior is an AI policy of behavior for an autonomous vehicle, and the state factors are associated with a semantic abstraction.

In other features, the semantic abstraction includes one or more sections adjacent to the autonomous vehicle.

In other features, displaying the notification regarding the causal reason for the action resulting from the current state includes displaying, on a display in the autonomous vehicle, the notification regarding the causal reason for the action resulting from the current state.

In other features, the notification includes a graphical representation highlighting an area adjacent to the autonomous vehicle in which at least one section is located.

In other features, the notification includes a description of the area adjacent to the autonomous vehicle in which the at least one section is located.

In other features, a size of the area adjacent to the autonomous vehicle is adjustable based on a parameter of the autonomous vehicle and/or a traffic distribution density near the autonomous vehicle.

In other features, a color of the highlighted area is adjustable based on a confidence value associated with the at least one section.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example system for generating a causal machine learning model summarizing states, resulting actions and impactful state factors, according to the present disclosure;

FIG. 2 is a functional block diagram of an example system for providing explanation of AI policy of behavior with causal reasoning based on the causal machine learning model of FIG. 1, according to the present disclosure;

FIG. 3 is a vehicle including portions of the system of FIG. 2, according to the present disclosure;

FIG. 4 depicts a graphical view of the vehicle of FIG. 3 centered within a defined perimeter and having an area surrounding the vehicle divided into eight sections, according to the present disclosure;

FIG. 5 depicts a graphical view of the vehicle of FIG. 3 centered within a defined perimeter and having an area surrounding the vehicle divided into eight sections, where the vehicle is merging onto a highway according to the present disclosure;

FIG. 6 is a flowchart of an example control process for generating a causal machine learning model for subsequently predicting causes to states and actions, according to the present disclosure;

FIG. 7 is a flowchart of an example control process for training a causal machine learning model for subsequently predicting causes to states and actions, according to the present disclosure; and

FIGS. 8-10 are flowcharts of example control processes for providing explanation of AI policy of behavior with causal reasoning, according to the present disclosure.

In the drawings, reference numbers may be reused to identify similar and/or identical elements.

### DETAILED DESCRIPTION

AI algorithms are applied to compute and determine automated decisions, such as driving behaviors for semi-autonomous and fully autonomous vehicles. While automated decision making is generally beneficial, particularly in vehicle applications, conventional systems often do not explain or adequately explain the reasoning behind automated behaviors to users (e.g., drivers, passengers, etc.). For example, in complex automated behaviors resulting from the application of AI algorithms to real life problems, it may be desirable to provide notifications that explain the behaviors to users. Such notifications can improve the users' trust in a system by explaining why the system took a particular action. For instance, automated driving can enhance its users' experience by adding automatically computed notifications, explaining the vehicle actions, such as harsh brakes, speeding up, changing lanes, etc.

The systems and methods according to the present disclosure enable the computation of explanations for automated behaviors by leveraging the identification of state factors with the highest responsibility scores (e.g., causal impact) on the automated actions chosen for execution. As further explained herein, the systems and methods herein may utilize offline computing solutions for determining responsibility scores over state factors and subsets thereof and generating a causal model summarizing states, actions and impactful state factors, and online computing solutions for providing causal explanations in real time based on the causal model constructed offline. With such causal explanations, content explaining the actions (e.g., vehicle actions) taken may be displayed or otherwise provided to users, thereby improving situational awareness of the users and increasing the coverage of situations when information might be found relevant to the users. For example, in vehicle applications, potential threats affecting the driving maneuvers of an automated driving vehicle may be marked and displayed on a human machine interface (HMI) display in real time. With this information, users may become more aware and understanding of the automated behaviors, and as a result gain trust in the automated system.

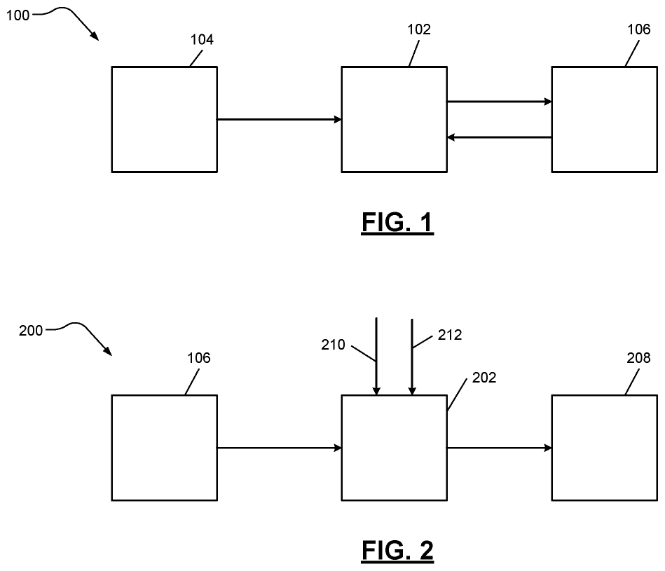

Referring now to FIGS. 1-2, block diagrams of example systems 100, 200 are presented for providing explanation of AI policy of behavior with causal reasoning. As shown in FIGS. 1-2, the system 100 generally includes a control module 102, a database 104, and a memory circuit 106, and the system 200 generally includes a control module 202, the memory circuit 106, and a display module 208. In various embodiments, and as further explained herein, the system 100 may be used in an offline state or mode (e.g., not implemented for real time use) to determine responsibility scores over state factors and generate a causal model summarizing states, actions and impactful state factors. Additionally, the system 200 may be used in an online state or mode (e.g., implemented for real time use) to provide causal explanations in real time based on the causal model constructed offline.

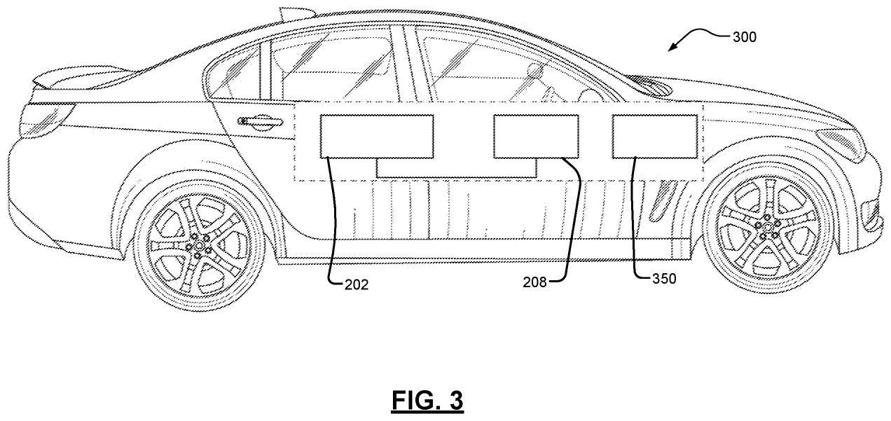

In various embodiments, the system 100, 200 of FIGS. 1-2 may be employable in vehicle applications. For example, the system 100 may be employed in offline scenarios for vehicle applications to collect data to determine the causes for a given state and resulting action and construct a summary (e.g., a model) that can be used online, as explained herein. The system 200 may then be employed in online scenarios for vehicle applications to use the previously constructed or implemented model, as explained herein. In some examples, the constructed model can be also used offline (e.g., as a summary). In vehicle application examples, the system 200 or a portion thereof may be implemented in any suitable autonomous (e.g., semi-autonomous or fully autonomous) vehicle, such as an electric vehicle (EV), an internal combustion engine vehicle, etc. For example, FIG. 3 depicts an autonomous vehicle 300 including the control module 202 and the display module 208 of FIG. 2, and one or more sensors 350 (e.g., one or more sensors and/or cameras) mounted on the exterior and/or interior of the vehicle 300. The sensors 350 generally obtain information about the surroundings or environment of the vehicle 300, and transmit such information to the control module 202 for computing possible actions for the autonomous vehicle 300 based on the obtained information and for implementing one or more of the possible actions.

While the systems 100, 200 of FIGS. 1-2 are generally described herein relative to the automated driving of a vehicle (e.g., the vehicle 300), it should be appreciated that the systems 100, 200 may be implemented with suitable non-vehicle applications. For example, the systems and methods herein may be implemented in routing (navigation) and congestion control, EV automated charging (e.g., proactively deciding when to charge and when to supply energy back to the grid, etc.), thermal comfort control, resources management (e.g., fleet control, etc.), etc. In addition, the systems 100, 200 may be implemented in other vehicle applications, such as other modes of transportation (e.g., a plane, a train, etc.), etc.

With reference to the system 100 of FIG. 1, the control module 102 collects data relating to various states and actions resulting from the states according to an AI policy of behavior. Once the data is collected, the control module 102 may generate a data structure (e.g., organize such data into a table form). In such examples, the data structure (e.g., the table) may have two columns, one for the states and the other for the corresponding actions (e.g., a single action for a state). Each action may be computed according to the AI policy as the action that will be executed once that state is encountered. In various embodiments, the states and resulting actions may be indexed (e.g., 0-6 for seven different actions as referenced below).

In some examples, the database 104 may store information, code, etc. relating to the collection of data. For example, the database 104 may store a description of what action needs to be taken at each state. In model-based planning systems, the AI policy may be computed offline by the control module 102 and can be retrieved as a function of a state. However, in different planning systems, the AI policy might be known as a result of running some code, such as in a Monte Carlo Tree Search. In such examples, collecting pairs of states and corresponding actions might be needed for further use of the policy for causal explanations.

In various embodiments, the collected states may relate to various parameters of a vehicle (e.g., an ego) and the actions are actions taken by the vehicle. The parameters associated with the vehicle may include, for example, a position (e.g., an x and y position) of the vehicle, a heading of the vehicle, a velocity (e.g., a longitudinal velocity and a lateral velocity) of the vehicle, a lane change status, a distance to a target, a relative heading of other neighboring vehicles, a relative position to other neighboring vehicles, a relative velocity to other neighboring vehicles, etc. The resulting actions may include, for example, different levels of vehicle acceleration/deceleration, directional lane changes, etc. For instance, the states may include ‘ego_pos_x’, ‘ego_pos_y’, ‘ego_heading’, ‘ego_vel_lon’, ‘ego_vel_lat’, ‘ego_lane’, ‘ego_lane_change_status’, ‘ego_distance_to_target’, ‘inRadius’, ‘laneChangeStatus’, ‘relHeading’, ‘relPosLat’, ‘relPosLon’, ‘relVelLat’, ‘relVelLon’. In such examples, some of the parameters, such as the relative parameters, may be repeated for each one of a defined number (e.g., fifteen, twenty, twenty-five, etc.) of vehicles considered in the traffic around the ego vehicle. Additionally, the actions may include seven different actions such as, for example, ‘strong_acc’, ‘Accelerate’, ‘strong_dec’, ‘decelerate’, ‘Left_lane_change’, ‘Right_lane_change’, and ‘none’.

The data collection can be done in different ways. For example, the collection may include a clean targeted collection or a dirty targeted collection. In a clean targeted collection, the control module 102 receives an AI policy and performs a sample collection by applying the AI policy over many evaluations to gather data on its performance. The dirty targeted collection is similar to the clean targeted collection, but where the control module 102 performs a sample collection by applying a received AI policy over many evaluations in which the computations may branch an evaluation at predetermined significant points during the evaluation to obtain a stronger coverage of the state/action space. In other examples, the collection may include a clean bootstrap of a Reinforcement Learning (RL) training process or a dirty bootstrap of an RL training process. For example, during an RL training process for a clean bootstrap, every iteration begins with applying the current AI policy for the current iteration on the environment and obtaining samples (states and resulting actions) indicative of the policy. In such examples, the collection may be refined by considering a sliding window over the collection (e.g., forgetting older samples that were obtained using older AI policies and keeping the newer samples that are a result of the more refined AI policies). The dirty bootstrap is similar to the clean bootstrap, but also allows the branching at predetermined significant points during the evaluation.

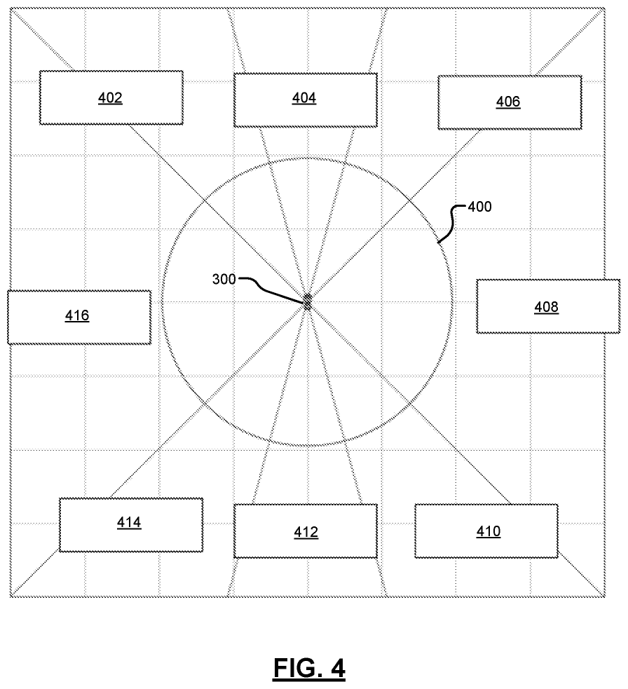

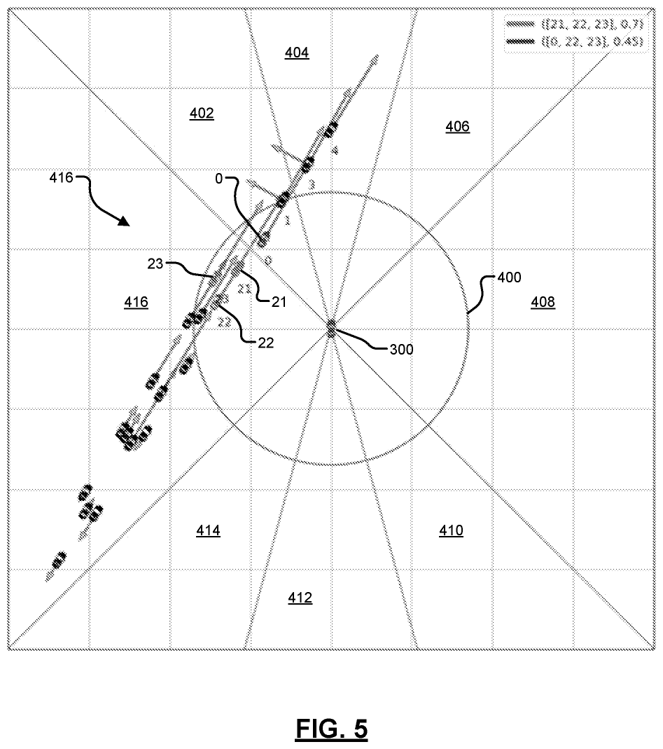

In various embodiments, the collected data may be reformulated based on defined semantic criterion. For example, the control module 102 may receive defined semantic criterion and then apply the semantic criterion to the collected data. In some examples, the semantic criterion may include defined sections around the vehicle. For example, FIG. 4 depicts a graphical view of the ego vehicle 300 of FIG. 3 centered within a defined perimeter 400. As shown, the area surrounding the ego vehicle 300 is divided into eight sections 402, 404, 406, 408, 410, 412, 414, 416. In this example, each section 402, 404, 406, 408, 410, 412, 414, 416 represents a different area adjacent to the vehicle 300.

Then, the control module 102 may reformulate the states and the actions into a table represented by indexes based on the criterion. For example, Table 1 below shows 24 indexes (listed as index 0 to index 23) for the traffic vehicles (the nearest vehicle, the second nearest vehicle and the third nearest vehicle) according to their semantic meaning with respect to the eight sections 402, 404, 406, 408, 410, 412, 414, 416 of FIG. 4. In such examples, traffic in each state is represented by the 24 indexes.

TABLE 1

| | ID | | |
|---|---|---|---|
| | Nearest | 2nd Nearest | 3rd Nearest |
| Section | Vehicle | Vehicle | Vehicle |
| 0 (402 of FIG. 4) | 0 | 1 | 2 |
| 1 (404 of FIG. 4) | 3 | 4 | 5 |
| 2 (406 of FIG. 4) | 6 | 7 | 8 |
| 3 (408 of FIG. 4) | 9 | 10 | 11 |
| 4 (410 of FIG. 4) | 12 | 13 | 14 |
| 5 (412 of FIG. 4) | 15 | 16 | 17 |
| 6 (414 of FIG. 4) | 18 | 19 | 20 |
| 7 (416 of FIG. 4) | 21 | 22 | 23 |

Next, the control module 102 may apply a defined discretization formulation to reduce the dimensionality of the data domain. For example, the control module 102 may assign values for the indexes based on a defined discretization formulation. In such examples, each index 0 to index 23 may be assigned a coding value taken from, for example, [0, 728]. For example, Table 2 below shows six different state's features (‘laneChangeStatus’, ‘relHeading’, ‘relPosLat’, ‘relPosLon’, ‘relVelLat’, ‘relVelLon’) and a matrix of conditions (positive, same, negative). In the example below, the conditions may be set based on ranges of values. For example, if a value is in a first range of values, then the condition may be set to “positive”. Additionally, if a value is in a second range of values, then the condition may be set to “same”. Further, if a value is in a third range of values, then the condition may be set to “negative”. Then, for each combination of set conditions (positive, same, or negative) in a row, a coding value between 0-728 may be assigned. For example, if the combination of the set conditions is all “positive”, then the coding value is assigned to 1 as shown in Table 2. In various embodiments, each value associated with the different states may be computed based on a conventional expectation-maximization (E/M) algorithm for obtaining a discretization model (or formulation) for the vehicle.

TABLE 2

| ‘laneChange | ‘rel | ‘relPos | ‘relPos | ‘relVel | ‘rel | |
|---|---|---|---|---|---|---|
| Status' | Heading’ | Lat’ | Lon’ | Lat’ | VelLon’ | code |
| positive | positive | positive | positive | positive | positive | 1 |
| positive | positive | positive | positive | positive | same | 2 |
| positive | positive | positive | positive | positive | negative | 3 |
| positive | positive | positive | positive | same | positive | 4 |
| positive | positive | positive | positive | same | same | 5 |
| positive | positive | positive | positive | same | negative | 6 |
| positive | positive | positive | positive | negative | positive | 7 |
| . . . | . . . | . . . | . . . | . . . | . . . | . . . |

Then, the control module 102 may determine state factors associated with the states and responsibility scores for the state factors. In such examples, each responsibility score indicates a causal impact for one of the resulting actions associated with one of the states. For example, the control module 102 can determine one or more neighboring vehicles (e.g., state factors in this case) may be responsible for a resulting action (e.g., a strong acceleration) of a state. Then, the control module 102 can determine a responsibility score for each neighboring vehicle that plays a part in (e.g., is responsible for) the resulting vehicle action. In such examples, the control module 102 may determine the state factors and associated responsibility scores based on the assigned values for the indexes.

In various embodiments, the control module 102 may employ an algorithm to determine state factors and their responsibility scores. For example, the control module 102 may implement one or more algorithms based on the algorithms provided in the article entitled “Causal Explanations for Sequential Decision Making Under Uncertainty” and published on Jan. 10, 2023, which is incorporated herein in its entirety.

In such examples, the control module 102 may identify vehicles within a defined distance from the ego vehicle (e.g., within a radius of the defined perimeter 400 of FIG. 4). In various embodiments, the control module 102 may determine a Euclidean distance between neighboring vehicles and the ego vehicle (e.g., the vehicle 300 of FIG. 4) and identify each vehicle within the defined distance based on the Euclidean distance for that vehicle.

Then, the control module 102 can determine a responsibility score for each of the identified vehicles. In various embodiments, the control module 102 may determine a responsibility score based on equations (1)-(4) below. For example, with respect to a given set of states S, S′ (of equation (1) below) includes those states where the features that are being tested for being a weak cause maintain their assignment as in an original state s in the set of states S. However, the variables in a contingency state can have a different assignment of values from that in the original state s in the set of states S. As such, if it is desirable to show that the features tested for being a cause, are indeed a cause, it means that no matter the assignments applied to the other variables in the set of states S (of length determined by a β (beta) parameter), then changing these values should not change the decision of action that was found by the AI policy. In other words, S′ comprises all states s in the set of states S such that when the values of the variables in a contingency set have changed, the action for that state did not change (and remains as the same action chosen for the corresponding state s in the set of states S). S̅ of equation (1) below is a collection of all the state S′. S̅ of equation (2) below is a collection of states in [symbol] where the action is different when the assignments of the contingency set are changed.

In equation (3) below, σ (sigma) is the proportion between the size of the set (i.e., S̅) where changing the assignments change the original action to the size of the set (i.e., S̅) where changing the assignments does not change the original action. In such examples, σ (sigma) is defined by a fraction with S̅ in the numerator and S̅ in the denominator, as shown in equation (3).

In equation (4) below, ρ (rho) represents the responsibility score, and β (beta) represents a size of a contingency set. For example, the features in a state s in a set of states S may be x1, x2, x3 and x4. When testing whether x1 is the cause of an action a chosen for some assignment of values of this vector, x1 can be tested for singletons taken from x2, x3, x4 or pairs or triplets. In this case, β (beta) can be 1, 2 or 3. But when computing the cause for the action, it is possible to define beta_max as 2. In such examples, only singletons and pairs are tested and not triplets of x2, x3 and x4.

$$\overline{\overline{S}} ← \overline{\overline{S}} ⋃ {S}^{′} \qquad ( 1 )$$

$$\overline{S} ← \overline{S} ⋃ \qquad ( 2 )$$

$$σ ← \frac{\vert \overline{S} \vert}{\vert \overline{\overline{S}} \vert} \qquad ( 3 )$$

$$ρ ← ρ + \frac{σ}{1 + β} \qquad ( 4 )$$

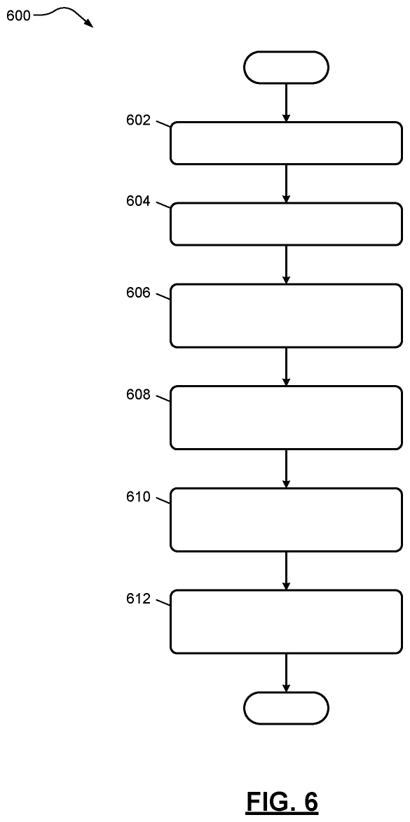

For example, FIG. 5 depicts a graphical view of the ego vehicle 300 of FIG. 3 centered within the defined perimeter 400 of FIG. 4 and the eight sections 402, 404, 406, 408, 410, 412, 414, 416 of FIG. 4 representing different areas adjacent to the vehicle 300. In the example of FIG. 4, the ego vehicle 300 is merging onto a highway, with multiple vehicles to the left of the ego vehicle 300 in the sections 402, 404, 416. In the example of FIG. 5, the control module 102 may identify vehicles 21, 22, 23 (e.g., within the defined perimeter 400) as state factors responsible for causing the vehicle 300 to accelerate and determine a responsibility score of 0.7 for such state factors. Additionally, the control module 102 may identify vehicles 0, 22, 23 (e.g., within the defined perimeter 400) as state factors responsible for causing the vehicle 300 to strongly accelerate and determine a responsibility score of 0.45 for such state factors. In other examples, the vehicles 0, 21, 22, 23 and/or other vehicles in the sections 402, 404, 416 may cause other actions of the vehicle 300.

With continued reference to FIG. 1, the control module 102 may then generate a causal machine learning (ML) model based on the state factors and the responsibility scores. For example, the control module 102 may utilize data with the actual causes for each data point to generate the causal ML model, which can be subsequently used to predict causes to states and actions as further explained below. In such examples, the data may include states, resulting actions for the states, state factors responsible for the actions, and associated responsibility scores.

The control module 102 may generate the causal ML model in any suitable manner. For example, the control module 102 may divide a set of data associated with the state factors and associated responsibility scores into a training subset and a testing subset. The control module 102 may utilize the training subset to train the causal ML model for predicting causes for a given state. Then, the control module 102 can test the causal ML model with the testing subset to determine whether the causal ML model is sufficiently trained. If not, the control module 102 may continue to train the causal ML model. If so, the control module 102 may store the trained causal ML model in the memory circuit 106.

In the example of FIG. 1, the causal ML model may be any suitable model. For example, the causal ML model may include an ensemble of trees (e.g., random forest, XGBoost, etc.), a neural network, a heuristic rule-based model, etc.

With reference now to the system 200 of FIG. 2, the control module 202 may be leveraged in an online state or mode (e.g., implemented for real time use) to provide causal explanations in real time based on the causal ML model constructed offline. In such examples, the control module 202 may be positioned in the vehicle 300 as shown in FIG. 3. In such examples, the control module 202 may be considered a vehicle control module. In other examples, the control module 202 may be external to the vehicle 300 but in communication with a vehicle control module in the vehicle 300.

In the example of FIG. 2, the control module 202 may receive or otherwise access the causal ML model stored in the memory circuit 106. Then, the control module 202 determines, while the system 200 is online, state factors (e.g., semantic sections or any other abstract or semantic representation over the original state features) and responsibility scores for the state factors based on the generated causal ML model.

For example, and as shown in FIG. 2, the control module 202 may receive a current state 210 and a resulting action 212 (e.g., signals representing the state and resulting action) for a vehicle (e.g., the vehicle 300 of FIG. 3) driving in real time. In such examples, the control module 202 may generally organize the received data as explained above relative to the control module 102 of FIG. 1. For example, the control module 202 may organize the data semantically (e.g., based on defined semantic criterion) and discretize the semantic data (e.g., based on a defined discretization formulation), as explained above.

Then, the control module 202 may apply the causal ML model that was constructed offline to the data and output a semantic cause predicted for the action in real time. For example, the control module 202 may determine, based on the causal ML model, state factors and responsibility scores for the state factors. In such examples, the state factors may include one or more semantic sections or areas adjacent to the vehicle 300 having causal effects on the received current state 210 and resulting action 212.

The control module 202 may then identify, based on the determined responsibility scores, one or more of the state factors as a causal reason for the received action resulting from the state. For example, the control module 202 may define one or more similarity measures to compare the current state 210 with the states learned by the causal ML model. The similarity measures may be used because the data points encountered in real time may not be the same as the data points encountered in the data set to train the causal ML model. Then, the control module 202 may predict the state factors (e.g., one of the sections adjacent to the vehicle 300) that includes a potential cause for the action based on the similarity measures (e.g., without specifying which vehicle in the real time scene is the actual cause). For instance, the control module 202 may predict that the identified section or area (e.g., a state factor) with the highest responsibility score as the causal reason for the action resulting from the current state. As one example, the control module 202 may predict that a particular identified section or area on the left of the vehicle has the highest impact (e.g., responsibility score) on the vehicle 300 decelerating. In other examples, the control module 202 may predict that identified vehicles in northeast section (e.g., section 402 of FIG. 5) relative to the vehicle 300 are affecting the current driving behavior of the vehicle 300.

In various embodiments, the control module 202 may cause the display module 208 to display a notification regarding the causal reason for the action resulting from the current state 210. For example, the control module 202 may transmit a signal to the display module 208 positioned in the vehicle 300 of FIG. 3. In such examples, the signal may include a particular identified section (e.g., a state factor) or multiple identified sections (e.g., state factors) with the highest responsibility score as the causal reason for the action 212 resulting from the current state 210. Then, the display module 208 (e.g., a dynamic HMI display) may display for an occupant (e.g., a driver, a passenger, etc.) of the vehicle 300 a notification identifying the particular section(s) as the causal reason for the action resulting from the current state 210.

The notification displayed by the display module 208 may include any suitable type and/or format of information for the occupant. For example, the notification may include a graphical representation highlighting an area adjacent to the vehicle 300 in which the identified section(s) are located. For instance, the display module 208 may display a graphical view similar to the graphical view of FIG. 5 but with the section 416 highlighted. In such examples, the highlighted section may include the state factors with the highest responsibility scores.

In other examples, the notification may include a description of the area adjacent to the vehicle 300 in which the identified section(s) are located. For example, the notification may generally explain a pattern of the semantic area relative to the traffic pattern. In such examples, the notification may provide that the potential threats are in the crowded area of traffic to the left (relative to the vehicle 300), the potential threats are behind (relative to the vehicle 300) when we decelerate, etc.

In some examples, features of the notification may change relative to parameters associated with the vehicle 300. For example, the notification may include one or more areas (e.g., sections) adjacent to the vehicle. In such examples, a size of one or more areas may be adjusted based on a speed of the vehicle 300, the density of the traffic distribution around the vehicle 300, etc. For example, when the speed of the vehicle 300 is high (e.g., over a defined threshold, such as 100 km/hour, 115 km/hour, etc.) and the traffic is crowded, the notification may include larger sections. Alternatively, when the traffic is sparse and/or the speed of the vehicle 300 is relatively slow, the notification may include smaller sections.

In still other examples, the notification may include indicate a confidence level associated with the highlighted area, the causal reason, etc. For example, the display module 108 may adjust a color of the highlighted area based on a confidence value associated with the identified vehicle(s). In such examples, the color may be adjusted within a range of colors, with lighter colors expressing less confident values whereas darker colors expressing more confident values. In other examples, the intensity of the color for the highlighted area may be changed, with a lower intensity (e.g., dim) expressing less confident values and a high intensity expressing high confident values. In various embodiments, the confidence value may be determined based on the similarity measure(s) used to compare the current state 210 with the states learned by the causal ML model.

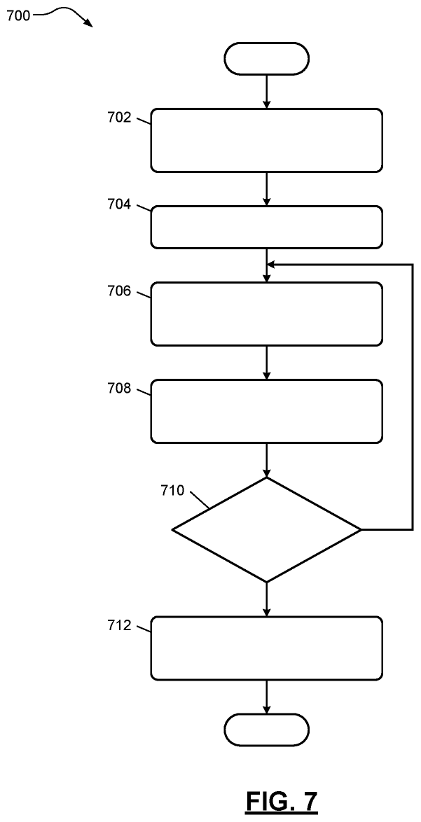

FIGS. 6-10 illustrate example control processes 600, 700, 800, 900, 1000 employable by the system 100 of FIG. 1 and/or the system 200 of FIG. 2. More specifically, the control processes 600, 700 may be implemented by the system 100 of FIG. 1 while in an offline state or mode (e.g., not implemented for real time use), and the control processes 800, 900, 1000 may be implemented by the system 200 of FIG. 2 while in an online state or mode (e.g., implemented for real time use). Although the example control processes 600, 700, 800, 900, 1000 are described in relation to the system 100 of FIG. 1 and/or the system 200 of FIG. 2 including the control modules 102, 202, any one of the control processes 600, 700, 800, 900, 1000 may be employable by another suitable system.

In FIG. 6, the control process 600 is employable for generating a causal ML model for subsequently predicting causes to states and actions. As shown, the control process 600 begins at 602, where the control module 102 of FIG. 1 collects data relating to various states and actions resulting from the states according to an AI policy of behavior. As explained above, the AI policy of behavior may be received by or generally accessible by the control module 102, and the collected states may relate to various parameters of a vehicle and the actions are actions taken by the vehicle. Control then proceeds to 604 and 606.

At 604, the control module 102 reformulates or organizes the collected data into a table with indexes based on defined criterion as explained above. For example, the defined criterion may be semantic criterion having defined sections around a vehicle, as explained above. Then, at 606, the control module 102 assigns values to each index based on defined discretization formulation to, for example, reduce the dimensionality of the data domain as explained above. Control then proceeds to 608.

At 608, the control module 102 determines state factors associated with the collected states and responsibility scores for the state factors. For example, the control module 102 may employ an algorithm to determine state factors and their responsibility scores based on the equations (1)-(4) as explained above. Control then proceeds to 610.

At 610, the control module 102 generates a causal ML model based on the determined state factors and the responsibility scores. For example, and as explained herein, the control module 102 may train a causal ML model with the determined state factors and the responsibility scores. Control then proceeds to 612, where the control module 102 stores the causal ML model in a memory circuit (e.g., the memory circuit 106 of FIG. 1. Control may then end as shown in FIG. 6.

In FIG. 7, the control process 700 is employable for training a causal ML model for subsequently predicting causes to states and actions. As shown, the control process 700 begins at 702, where the control module 102 accesses state factors associated with states and responsibility scores for the state factors (e.g., that may be generated in step 608 of FIG. 6). Control then proceeds to 704, where the control module 102 divides the accessed data into a training subset and a testing subset. Control then proceeds to 706.

At 706, the control module 102 trains a causal ML model according to the training subset of state factors and associated responsibility scores. Control then proceeds to 708, where the control module 102 generates an output score with the causal ML model based on the testing subset of state factors and associated responsibility scores. Control then proceeds to 710.

At 710, the control module 102 determines the output score is greater than a defined threshold. For example, the defined threshold may be any suitable value indicating whether the causal ML model is sufficiently trained. If the output score is not greater than the defined threshold at 710, control returns to 706 where the control module 102 continues to train the causal ML model. Otherwise, if the output score is greater than the defined threshold at 710, control proceeds to 712 where the control module 102 stores the causal ML model in a memory circuit (e.g., the memory circuit 106 of FIG. 1. Control may then end as shown in FIG. 7.

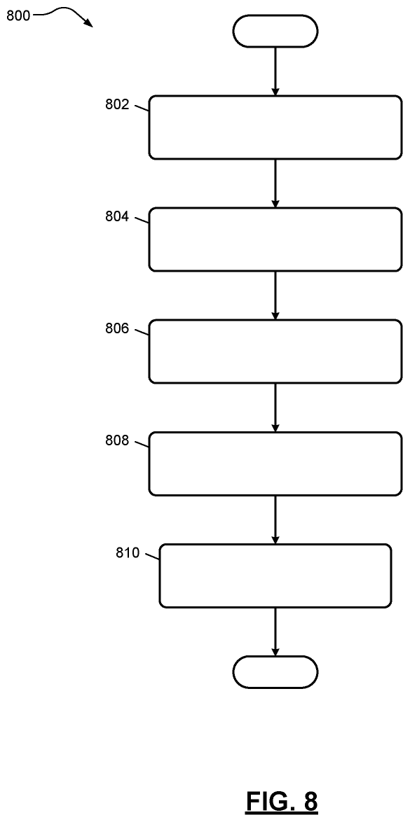

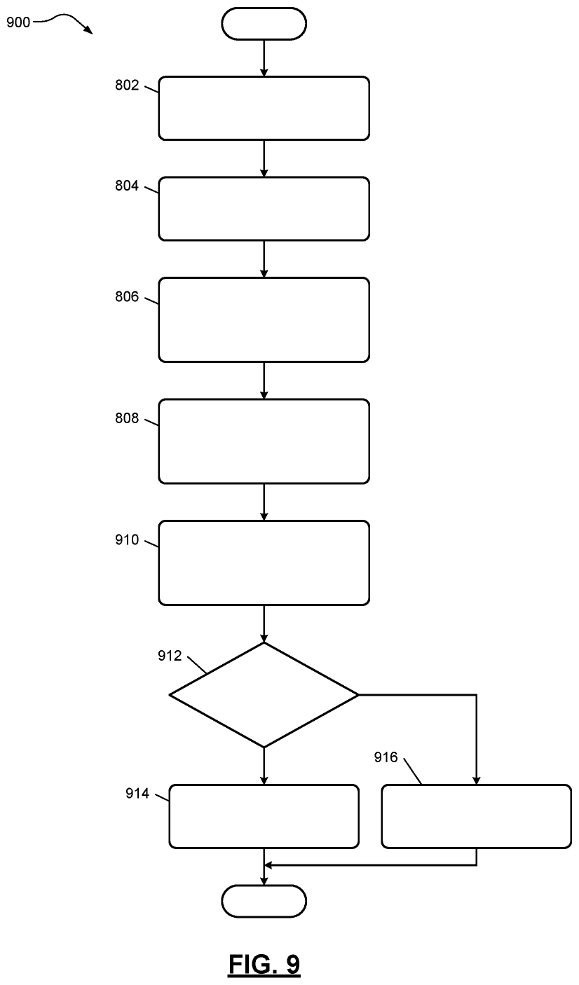

In FIG. 8, the control process 800 is employable for providing explanation of AI policy of behavior with causal reasoning. As shown, the control process 800 begins at 802, where the control module 202 of FIG. 2 receives or otherwise accesses a trained causal ML model for online use in a vehicle (e.g., the autonomous vehicle 300 of FIG. 3). Control then proceeds to 804, where the control module 202 receives a current state (e.g., the current state 210 of FIG. 2) and resulting action (e.g., the resulting action 212 of FIG. 2) for a policy of behavior. Control then proceeds to 806.

At 806, the control module 202 applies the trained causal ML model to the current state and resulting action to identify state factors and their associated responsibility scores. For example, and as explained above, the control module 202 may identify areas around the vehicle and determine their associated responsibility scores. In such examples, the areas may be functions of the state factors, and the responsibility scores may be computed for the state factors according to the algorithm for finding a responsibility score, as explained above. Control then proceeds to 808.

At 808, the control module 202 identifies the state factor or factors having the highest associated responsibility score as the causal reason for the current state and resulting action. For example, and as explained above, the control module 202 may predict that one or more of the areas around the vehicle include a potential threat if the area(s) has the highest responsibility score. For instance, the control module 202 may determine that an area to the left of the vehicle has the highest responsibility score and then identify that area as likely including a potential threat (e.g., a vehicle) as the reason for the resulting action. Control then proceeds to 810.

At 810, the control module 202 displays a notification with the causal reason for the action resulting from the current state. For example, and as explained above, the control module 202 may transmit a signal to the display module 208 of FIG. 2 positioned in the vehicle 300 of FIG. 3 to cause the display module 208 to display the notification providing the causal reason. As explained above, the displayed notification may include various types and/or formats of information for the occupant (e.g., a driver, a passenger, etc.) in the vehicle 300. Control may then end as shown in FIG. 8.

In FIG. 9, the control process 900 is employable for providing explanation of AI policy of behavior with causal reasoning. As shown, the control process 900 begins with the steps 802, 804, 806, 808 as explained above relative to the control process 800 of FIG. 8. Then, the control process 900 of FIG. 9 proceeds to 910.

At 910, the control module 202 determines a confidence value for the identified state factor or factors (e.g., the causal vehicle(s) for the current state and resulting action. For example, and as explained above, the control module 202 may determine a confidence value based on one or more similarity measures used to compare the current state with the states learned by the causal ML model (constructed offline). Control then proceeds to 912.

At 912, the control module 202 determines whether the confidence value is greater than a defined threshold. If yes, control proceeds to 914 where the control module 202 displays (e.g., causes the display module 108 of FIG. 1 to display) a defined area (e.g., one or more sections) adjacent to the vehicle 300 with the identified state factor or factors in a first color (or a first range of colors). In such examples, the first color may be a dark shade of a particular color, a dark color (e.g., red, etc.), etc. Control may then end as shown in FIG. 9. If no at 912, control proceeds to 916 where the control module 202 displays the defined area adjacent to the vehicle 300 with the identified state factor or factors in a second color (or a second range of colors), such as a light shade of a particular color (e.g., the same general color as the first color but in a lighter shade), a light color (e.g., yellow). Control may then end as shown in FIG. 9.

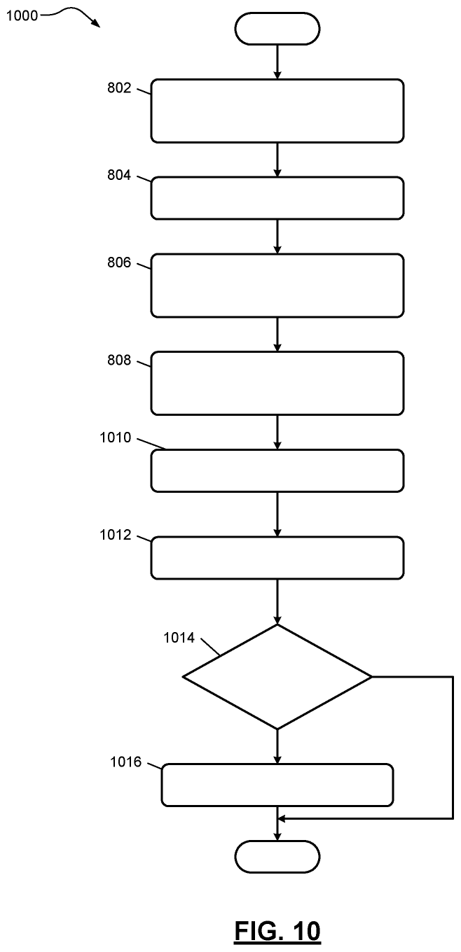

In FIG. 10, the control process 1000 is employable for providing explanation of AI policy of behavior with causal reasoning. As shown, the control process 1000 begins with the steps 802, 804, 806, 808 as explained above relative to the control process 800 of FIG. 8. Then, the control process 1000 of FIG. 10 proceeds to 1010, where the control module 202 displays a notification with a defined area adjacent to the vehicle 300 with the identified state factor or factors (e.g., an identified section adjacent to the vehicle) with the highest responsibility score (the causal impact) for the current state and resulting action, as explained above. Control then proceeds to 1012.

At 1012, the control module 202 determines one or more parameters associated with the vehicle 300. For example, and as explained above, the control module 202 may determine a speed of the vehicle 300 and/or a density of the traffic distribution around the vehicle 300 based on information received from one or more vehicle sensors. Control then proceeds to 1014.

At 1014, the control module 202 determines whether the parameter(s) associated with the vehicle 300 are greater than one or more defined thresholds. For example, the control module 202 may compare the speed of the vehicle 300 to a defined velocity value and the density of the traffic distribution to a defined traffic density value. If no at 1014, control may end as shown in FIG. 10. If, however, the parameter(s) exceed the defined threshold(s) at 1014, control proceeds to 1016, where the control module 202 adjusts a size of the defined area of the notification. For example, if the speed of the vehicle 300 is greater than the defined velocity value and the density of the traffic distribution indicates heavy traffic based on the defined traffic density value, then the control module 202 may increase the defined area of the notification. Control may then end as shown in FIG. 10.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A method for providing explanation of an artificial intelligence (AI) policy of behavior with causal reasoning, the method comprising:
generating a data structure including states and actions to be executed at those states as determined by the AI policy of behavior;
determining, with a first computing system that is offline, state factors associated with the states and responsibility scores for the state factors, each responsibility score indicating a causal impact for each of the actions associated with one of the states;
generating, with the first computing system, a causal machine learning (ML) model based on the state factors and the responsibility scores;
determining, with a second computing system that is online based on the generated causal ML model, state factors associated with a current state; and
identifying one or more of the state factors as a causal reason for an action resulting from the current state.

2. The method of claim 1, further comprising reformulating the states and the actions into a table represented by indexes based on one or more criterion.

3. The method of claim 2, wherein:
the AI policy of behavior is an AI policy of behavior for an autonomous vehicle; and
the one or more criterion includes a defined number of sections each representing a different area adjacent to the autonomous vehicle.

4. The method of claim 2, further comprising assigning values for the indexes based on a defined discretization formulation.

5. The method of claim 4, wherein determining, with the first computing system that is offline, the state factors and the responsibility scores includes determining the state factors and the responsibility scores based on the values for the indexes.

6. The method of claim 1, wherein:
the AI policy of behavior is an AI policy of behavior for an autonomous vehicle; and
the state factors are associated with a semantic abstraction.

7. The method of claim 6, wherein the semantic abstraction includes one or more sections adjacent to the autonomous vehicle.

8. The method of claim 7, further comprising displaying, on a display in the autonomous vehicle, a notification regarding the causal reason for the action resulting from the current state.

9. The method of claim 8, wherein the notification includes a graphical representation highlighting an area adjacent to the autonomous vehicle in which at least one section is located.

10. The method of claim 9, wherein the notification includes a description of the area adjacent to the autonomous vehicle in which the at least one section is located.

11. The method of claim 9, wherein a size of the area adjacent to the autonomous vehicle is adjustable based on a parameter of the autonomous vehicle and/or a traffic distribution density near the autonomous vehicle.

12. The method of claim 9, wherein a color of the highlighted area is adjustable based on a confidence value associated with the at least one section.

13. A method for providing explanation of an artificial intelligence (AI) policy of behavior with causal reasoning, the method comprising:
receiving a causal machine learning (ML) model;
determining, based on the causal ML model, state factors associated with a current state;
identifying one or more of the state factors as a causal reason for an action resulting from the current state; and
displaying a notification regarding the causal reason for the action resulting from the current state.

14. The method of claim 13, wherein:
the AI policy of behavior is an AI policy of behavior for an autonomous vehicle; and
the state factors are associated with a semantic abstraction.

15. The method of claim 14, wherein the semantic abstraction includes one or more sections adjacent to the autonomous vehicle.

16. The method of claim 15, wherein displaying the notification regarding the causal reason for the action resulting from the current state includes displaying, on a display in the autonomous vehicle, the notification regarding the causal reason for the action resulting from the current state.

17. The method of claim 16, wherein the notification includes a graphical representation highlighting an area adjacent to the autonomous vehicle in which at least one section is located.

18. The method of claim 17, wherein the notification includes a description of the area adjacent to the autonomous vehicle in which the at least one section is located.

19. The method of claim 17, wherein a size of the area adjacent to the autonomous vehicle is adjustable based on a parameter of the autonomous vehicle and/or a traffic distribution density near the autonomous vehicle.

20. The method of claim 17, wherein a color of the highlighted area is adjustable based on a confidence value associated with the at least one section.
